(19) United States
(12) Patent Application Publication
(10) Pub. No.: US 2007/0180512 A1
(43) Pub. Date: Aug. 2, 2007

(54) Methods of setting up and operating a reverse channel across a firewall

(75) Inventors: Abhijit Chaudhuri, Bangalore (IN); Denis Rachal, Stuttgart (DE); Sunil K.R., Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/491,188

(22) Filed: Jul. 24, 2006

(30) Foreign Application Priority Data
Oct. 21, 2005 (IN) IN2814/DEL/2005

(51) Int. Cl. G06F 15/16

(52) U.S. Cl. 726/12

(57) ABSTRACT

A method of setting up a reverse channel across a firewall, wherein the firewall is configured to enable entities internal to the firewall to originate connections across the firewall to entities external to the firewall but to block connections originating from entities external to the firewall, the method comprising the steps of: (a) using a server internal to the firewall to originate a connection across the firewall to a reverse channel proxy external to the firewall, the server and reverse channel proxy each having a role in relation to the connection, the server having a client role and the reverse channel proxy having a server role; and (b) initiating a role reversal process whereby the reverse channel proxy changes its role to a client role and the server changes its role to a server role. After the reverse channel has been set up, communication between a client external to a firewall, and a server internal to a firewall can be performed by sending a request to the server across the firewall via the reverse channel; receiving a response from the server across the firewall via the reverse channel; and forwarding the response to the client, wherein the reverse channel is set up to enable the request to be sent across the firewall in a form that would otherwise be blocked by the firewall.

This application claims priority from Indian patent application IN2814/DEL/2005, filed on Oct. 21, 2005; The entire content of the aforementioned application is incorporated herein by reference.

### BACKGROUND ART

A firewall is commonly used to separate an intranet on an internal side of the firewall from a Demilitarized Zone (DMZ) and the Internet on an external side of the firewall. Firewall administrators prefer that all connections between applications running on two sides of the firewall are outbound-only. That is, all communications originate from systems in the higher-trust zone (that is, on the internal side of the firewall), to systems in the lower-trust zone (that is, on the external side of the firewall). However, there may be situations where applications running in the lower-trust zone need to initiate connections with applications running in the higher-trust zone.

A conventional solution to this problem is presented in U.S. Pat. No. 6,349,336, in which a tunneling action is provided which allows a remote processor to communicate with a local processor when the remote processor is coupled to the local processor via a reverse proxy device, a computer network, a firewall and a proxy agent device. The tunneling action is provided by the reverse proxy device, which wraps requests from the remote processor by code which is recognised by the firewall as a response.

### BRIEF DESCRIPTION OF DRAWINGS

An embodiment of the invention will now be described by way of example with reference to the accompanying drawings, in which:

FIG. 1 is a flow diagram showing a method of setting up a reverse channel;

FIG. 2 is a block diagram of a computer system employing a reverse channel; and

FIG. 3 is a flow diagram showing the operation of the reverse channel.

### DETAILED DESCRIPTION OF THE PREFERRED EMBODIMENT

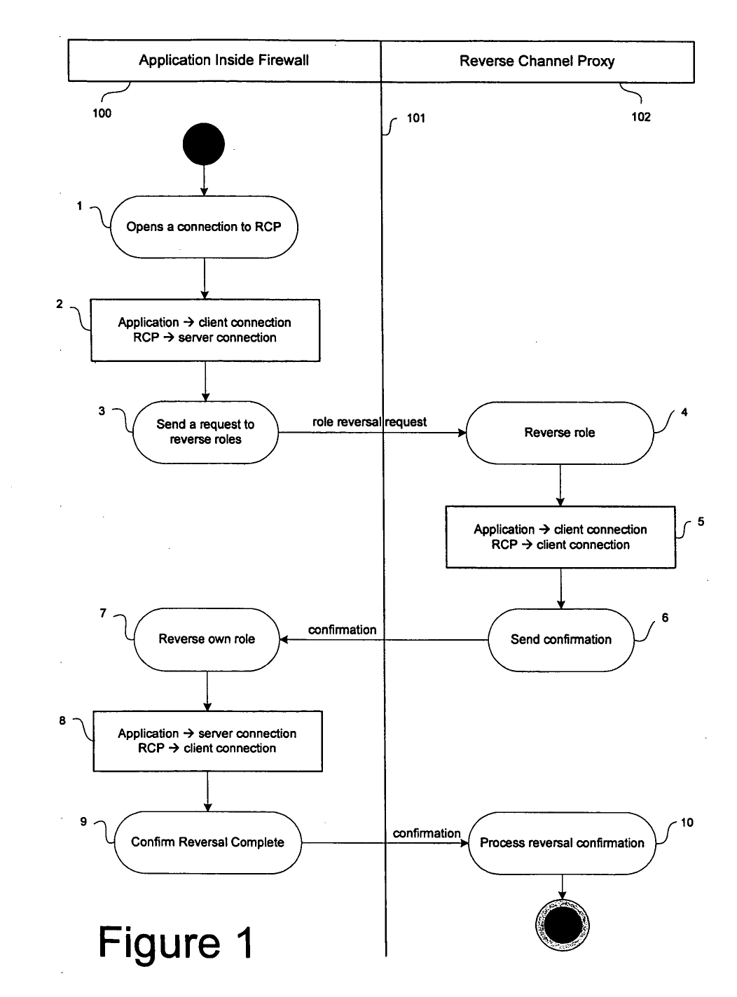

Referring to FIG. 1, an application 100 internal to a firewall 101 communicates with a reverse channel proxy 102 external to the firewall. The firewall 101 is configured to enable entities internal to the firewall to originate connections across the firewall to entities external to the firewall but to block connections originating from entities external to the firewall.

In a first step 1, the application 100 originates a connection to the reverse channel proxy 102. The server and the reverse channel proxy each have respective roles in relation to the connection. Initially the roles are allocated as shown at 2, with the application 100 allocated a client role (that is, a role in which it is configured to send requests) and the reverse channel proxy 102 allocated a server role (that is, a role in which is it configured to receive requests and send responses).

In step 3 the application 100 initiates a role reversal process by sending a role reversal request to the reverse channel proxy 102 across the firewall 101. In step 4 the reverse channel proxy 102 reverses its role in response to receipt of the role reversal request so as to change its role to a client role. This results in the connection having a configuration as shown at 5, with both the application 100 and reverse channel proxy 102 having client roles.

In step 6, the reverse channel proxy 102 sends a confirmation to the application 100 across the firewall 101. In response to receipt of the confirmation, the application 100 reverses its own role in step 7, so as to change its role to a server role. This results in the connection having a configuration as shown at 8 in which the application 100 and the reverse channel proxy 102 have reversed their roles. That is, the application 100 has a server role and the reverse channel proxy 102 has a client role.

In step 9 the application 100 confirms that reversal is complete by sending a confirmation message to the reverse channel proxy 102. In step 10 the reverse channel proxy 102 processes the reversal confirmation message. At this point, the reverse channel has been set up and is saved in cache memory.

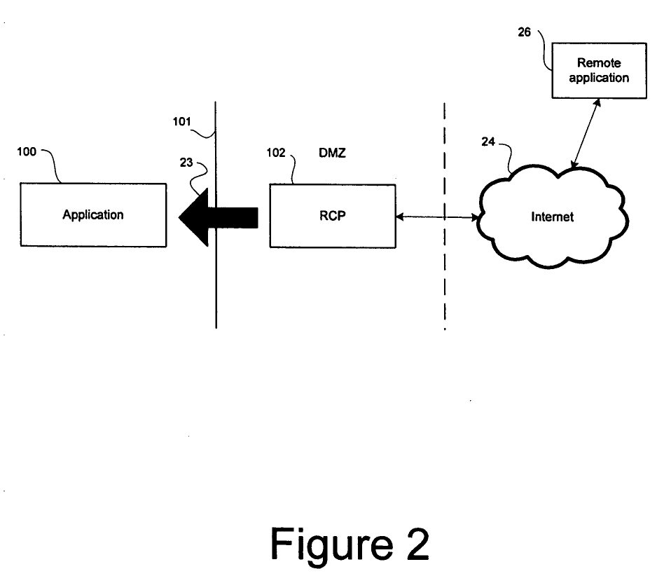

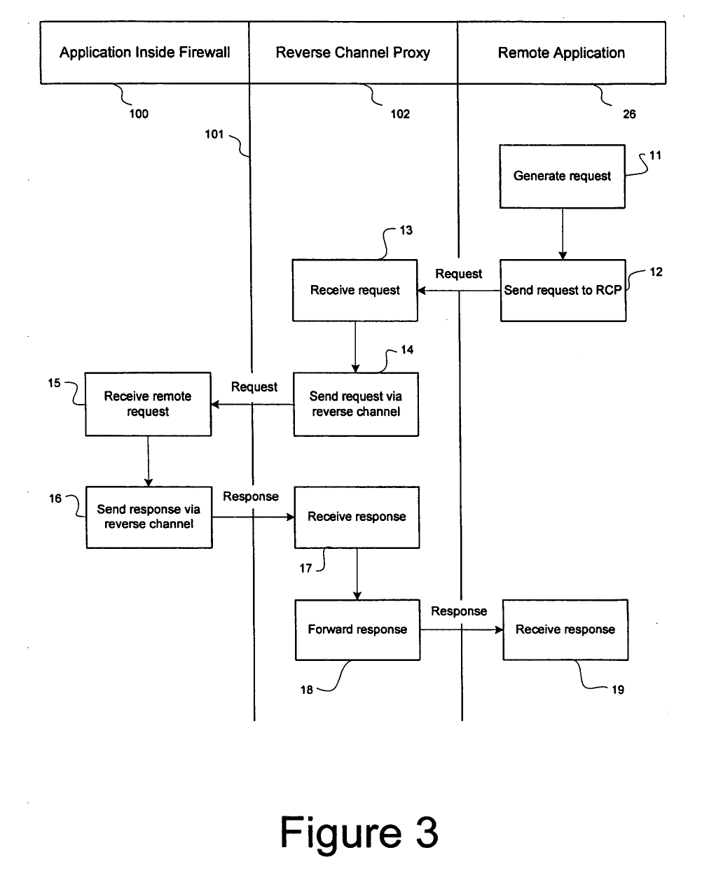

FIG. 2 illustrates a computer system including the reverse channel 23, and a remote application 26 communicating with the reverse channel proxy 102 via the internet 24. The applications 100, 26 communicate as shown in FIG. 3. The remote application 26 generates a request at step 11 and sends the request to the reverse channel proxy in step 12. In step 13 the reverse channel proxy 102 receives the request and sends it to the application 100 across the firewall via the reverse channel 23. Note that in contrast to U.S. Pat. No. 6,349,336, in which a reverse proxy wraps requests by code which is recognised by the firewall as a response, the reverse channel proxy 102 sends data across the firewall 101 in the form of a request which would normally be blocked by the firewall in the absence of the reverse channel 23. That is, the reverse channel 23 is set up to enable the request to be sent across the firewall in a form that would otherwise be blocked by the firewall. Also, the request is not sent across the firewall in response to a polling request from the application 100. As a result, the process has low latency in the sense that there is little time delay between steps 12 and 19, and efficient since it avoids the need for polling routines.

The application 100 receives the request in step 15, and sends a response in step 16 to the reverse channel proxy 102 across the firewall 101 via the reverse channel. In step 17, the reverse channel proxy 102 receives the response and in step 17 forwards the response to the remote application 26 which receives the response at step 19.

The low latency of the communication process shown in FIG. 3 enables various steps to be handled in a single session, where previously two separate sessions would have been required —one session between the remote application 26 and the reverse proxy 102, and another session between the server application 100 inside the firewall and the reverse proxy 102. Thus for example steps 12 to 19 may be part of a single Secure Socket Layer (SSL) session.

Although FIG. 3 has been illustrated with reference to a single remote application 26 only, a plurality of applications outside the firewall can be configured to use the reverse channel proxy 102 as a proxy to send requests to one or more applications inside the firewall.

The invention can be of use in any computer system which employs a firewall, and the various aspects of the invention can be implemented by appropriately configuring the application inside the firewall and the reverse channel proxy.

1. A method of setting up a reverse channel across a firewall, wherein the firewall is configured to enable entities internal to the firewall to originate connections across the firewall to entities external to the firewall but to block connections originating from entities external to the firewall, the method comprising the steps of:
a) using a server internal to the firewall to originate a connection across the firewall to a reverse channel proxy external to the firewall, the server and reverse channel proxy each having a role in relation to the connection, the server having a client role and the reverse channel proxy having a server role; and
b) initiating a role reversal process whereby the reverse channel proxy changes its role to a client role and the server changes its role to a server role.

2. A method according to claim 1 wherein the role reversal process comprises the steps of sending a role reversal request from the server to the reverse channel proxy; reversing the role of the reverse channel proxy in response to receipt of the role reversal request so as to change the role of the reverse channel proxy to a client role; sending a confirmation from the reverse channel proxy to the server; and reversing the role of the server in response to receipt of the confirmation so as to change the role of the server to a server role.

3. A method according to claim 2 further comprising sending a second confirmation from the server to the reverse channel proxy.

4. A method according to claim 1 further comprising saving the reverse channel in cache memory.

5. A computer system comprising a firewall; a server internal to the firewall; and a reverse channel proxy external to the firewall, wherein the server is configured to set up a reverse channel across a firewall by a method according to claim 1.

6. A method of operating a server internal to a firewall so as to set up a reverse channel across the firewall, wherein the firewall is configured to enable entities internal to the firewall to originate connections across the firewall to entities external to the firewall but to block connections originating from entities external to the firewall, the method comprising the steps of:
a) using the server to originate a connection across the firewall to a reverse channel proxy external to the firewall, the server and reverse channel proxy each having a role in relation to the connection, the server having a client role and the reverse channel proxy having a server role; and
b) initiating a role reversal process whereby the reverse channel proxy changes its role to a client role and the server changes its role to a server role.

7. A method according to claim 1 wherein the role reversal process comprises sending a role reversal request from the server to the reverse channel proxy; receiving a confirmation from the reverse channel proxy; and reversing the role of the server in response to receipt of the confirmation so as to change the role of the server to a server role.

8. A method according to claim 6 further comprising sending a second confirmation to the reverse channel proxy.

9. A method according to claim 6 further comprising saving the reverse channel in cache memory.

10. A server configured to set up a reverse channel by a method according to claim 6.

11. A method of operating a reverse channel proxy so as to set up a reverse channel across a firewall, wherein the firewall is configured to enable entities internal to the firewall to originate connections across the firewall to entities external to the firewall but to block connections originating from entities external to the firewall, the reverse channel proxy having initially been allocated a server role in relation to a connection originated by a server internal to the firewall, the method comprising: reversing the role of the reverse channel proxy so as to change the role of the reverse channel proxy to a client role.

12. A method according to claim 11 further comprising receiving a role reversal request from the server; reversing the role of the reverse channel proxy in response to receipt of the role reversal request so as to change the role of the reverse channel proxy to a client role; and sending a confirmation to the server.

13. A method according to claim 12 further comprising receiving a second confirmation from the server.

14. A method according to claim 11 further comprising saving the reverse channel in cache memory.

15. A reverse channel proxy configured to set up a reverse channel by a method according to claim 11.

16. A method of communicating between a client external to a firewall, and a server internal to a firewall, the method comprising: setting up a reverse channel across the firewall; sending a request to the server across the firewall via the reverse channel; receiving a response from the server across the firewall via the reverse channel; and forwarding the response to the client, wherein the reverse channel is set up to enable the request to be sent across the firewall in a form that would otherwise be blocked by the firewall.

17. A method according to claim 16 wherein the reverse channel is set up by a method according to claim 1.

18. A method according to 16 wherein the request is not sent to the server across the firewall in response to a polling request from the server.

19. A method according to claim 16 wherein the method is performed by a reverse channel proxy which receives the request from the client external to the firewall.

20. A method according to claim 16 wherein a plurality of clients external to the firewall are configured to use the reverse channel proxy as a proxy to send requests to one or more servers inside the firewall.

21. A method according to 16 wherein the steps of receiving the request from the client external to the firewall, sending the request to the server across the firewall via the reverse channel, receiving a response from the server across the firewall via the reverse channel, and forwarding the response to the client are part of a single session.

22. A method according to 21 wherein the session is a Secure Socket Layer (SSL) session.

23. A reverse channel proxy configured to communicate across a firewall by a method according to claim 16.

24. A computer system comprising a firewall; a server internal to the firewall; a client external to the firewall; and a reverse channel proxy external to the firewall, wherein the reverse channel proxy is configured to facilitate communication between the client and the server by a method according to claim 16.
